(19) United States
(12) Patent Application Publication
(10) Pub. No.: US 2016/0062511 A1
(43) Pub. Date: Mar. 3, 2016

(54) COORDINATE MEASURING DEVICES, COORDINATE MEASURING SYSTEMS AND COORDINATE MEASURING METHODS

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Sung-soo PARK, Suwon-si (KR); Byung-hoon KANG, Suwon-si (KR); Chang-byung PARK, Daejeon (KR); Gyu-hyeong CHO, Daejeon (KR)

(73) Assignees: KOREA ADVANCED INSTITUTE OF SCIENCE AND TECHNOLOGY, Daejeon (KR); SAMSUNG ELECTRONICS CO., LTD., Suwon-si (KR)

(21) Appl. No.: 14/828,630

(22) Filed: Aug. 18, 2015

(30) Foreign Application Priority Data
Aug. 27, 2014 (KR) 10-2014-0112330

(51) Int. Cl. G06F 3/044; G06F 3/041

(52) U.S. Cl. CPC G06F 3/044; G06F 3/0416

(57) ABSTRACT

Provided is a coordinate measuring device for sensing a location of a coordinate indicating device including a resonance circuit. The coordinate measuring device includes a panel including a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal; and a controller configured to sense at least one of a frequency and a phase of the resonance signal and adjust the driving signal according to the at least one of the frequency and the phase, which is sensed.

### RELATED APPLICATION

This application claims priority from Korean Patent Application No. 10-2014-0112330, filed on Aug. 27, 2014, in the Korean Intellectual Property Office, the disclosure of which is incorporated herein in its entirety by reference.

### BACKGROUND

1. Field

One or more exemplary embodiments relate to coordinate measurements, and more particularly, to coordinate measuring devices, coordinate measuring systems, and methods of measuring coordinates.

2. Description of the Related Art

Technologies relating to a contact location measuring device or a coordinate measuring device incorporated in electronic devices, such as smartphones, personal digital assistants (PDAs), or tablet PCs have been widely distributed. The electronic devices mainly include a touch screen, and accordingly, the electronic devices may be also referred to as touch input apparatuses. A user may designate a certain coordinate on a touch screen by using the user's finger or a stylus pen, and accordingly, the user may input a certain signal to the electronic devices by designating a certain coordinate on the touch screen.

### SUMMARY

One or more exemplary embodiments include a coordinate measuring device capable of improving a sensitivity of a resonance signal transmitted from a coordinate indicating device, a coordinate measuring system including the coordinate measuring device, and a method of measuring coordinates.

Additional aspects will be set forth in part in the description which follows and, in part, will be apparent from the description, or may be learned by practice of the presented exemplary embodiments.

According to one or more exemplary embodiments, a coordinate measuring device for sensing a location of a coordinate indicating device including a resonant circuit, the coordinate measuring device includes a panel including a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal, and a controller configured to sense at least one of a frequency and a phase of the resonance signal and adjust the driving signal according to the at least one of the frequency and the phase.

The controller may adjust a driving frequency of the driving signal such that the driving frequency is equal to the frequency of the resonance signal.

The controller may adjust a driving phase of the driving signal such that the driving phase is equal to the phase of the resonance signal.

The controller may include a sensor configured to sense the at least one of the frequency and the phase of the resonance signal and output information indicating the at least one of the frequency and the phase of the resonance signal.

The controller may further include a driver configured to adjust the at least one of the driving frequency and the driving phase of the driving signal according to the output information and provide the adjusted driving signal to at least one of the plurality of channel electrodes.

The controller may further include: a driving signal controller configured to generate a control signal for controlling the at least one of the driving frequency and the driving phase of the driving signal according to the output information, and a driver configured to adaptively adjust at least one of the driving frequency and the driving phase according to the control signal and provide the adjusted driving signal to at least one of the plurality of channel electrodes.

The sensor may include an analog to digital converter (ADC) configured to convert the resonance signal from an analog signal to a digital signal, and a detector configured to detect the at least one of the frequency and the phase of the digital signal.

The sensor may further include an amplifier configured to amplify the resonance signal and output the amplified resonance signal, and the ADC may be configured to convert the amplified resonance signal from an analog signal to a digital signal.

The detector may be configured to transform the digital signal from a temporal domain to a frequency domain and detect the at least one of the frequency and the phase of the digital signal that has been transformed to the frequency domain.

The detector may detect the at least one of the frequency and the phase by applying at least one of a fourier transformation, a fast fourier transformation (FFT), and a discrete fourier transformation (DFT) to the digital signal.

The controller may be configured to determine a timing of activating the driving signal according to the sensed phase.

According to one or more exemplary embodiments, a coordinate measuring device for sensing a location of a coordinate indicating device including a resonant circuit, the coordinate measuring device includes a panel including a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal, an amplifier configured to amplify the resonance signal; an analog to digital converter (ADC) configured to convert the amplified resonance signal from an analog signal to a digital signal, and a detector configured to detect a phase of the digital signal and output a driving time signal for adaptively adjusting the driving signal according to the detected phase.

The coordinate measuring device may further include a driver configured to provide the adjusted driving signal to at least one of the plurality of channel electrodes during a driving period according to the driving time signal.

According to one or more exemplary embodiments, a coordinate measuring system includes a coordinate indicating device including a resonant circuit, and a coordinate measuring device including: a panel including a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal, and a controller configured to sense at least one of a frequency and a phase of the resonance signal and adjust the driving signal according to the at least one of the frequency and the phase, which is sensed.

According to one or more exemplary embodiments, a coordinate measuring method for measuring a location of a coordinate indicating device in a coordinate measuring device including a plurality of channel electrodes, the coordinate measuring method includes transmitting a driving signal to the coordinate indicating device through capacitive coupling between at least one of the plurality of channel electrodes and the coordinate indicating device, where the coordinate indicating device resonates based on the driving signal, receiving a resonance signal from the coordinate indicating device through capacitive coupling between the at least one of the plurality of channel electrodes and the coordinate indicating device, sensing at least one of a frequency and a phase of the resonance signal, adjusting the driving signal according to the at least one of the frequency and the phase; and providing the adjusted driving signal to at least one of the plurality of channel electrodes.

The adjusting of the driving signal may include adjusting a driving frequency of the driving signal such that the driving frequency is equal to the sensed frequency.

The adjusting of the driving signal may include adjusting a driving phase of the driving signal such that the driving phase is equal to the sensed phase.

The adjusting of the driving signal may determine a timing of activating the driving signal according to the sensed phase.

The coordinate measuring method may further include generating a control signal for controlling at least one of a driving frequency and a driving phase of the driving signal according to the at least one of the frequency and the phase, wherein the adjusting the driving signal may include adjusting the driving signal according to the control signal.

The sensing of at least one of the frequency and the phase may include converting the resonance signal from an analog signal to a digital signal and detecting at least one of the frequency and the phase of the digital signal.

The sensing of at least one of the frequency and the phase may further include amplifying the resonance signal and outputting the amplified resonance signal, and the converting of the resonance signal from an analog signal to a digital signal may include converting the amplified resonance signal from an analog signal to a digital signal.

According to one or more exemplary embodiments, a method of measuring a location of a coordinate indicating device in a coordinate measuring device including a plurality of channel electrodes, the method includes transmitting a driving signal to the coordinate indicating device through capacitive coupling between at least one of the plurality of channel electrodes and the coordinate indicating device, where the coordinate indicating device resonates based on the driving signal, receiving a resonance signal from the coordinate indicating device through capacitive coupling between at least one of the plurality of channel electrodes and the coordinate indicating device, detecting a phase of the resonance signal, generating a driving time signal for adjusting the driving signal according to the sensed phase, and providing the driving signal to at least one of the plurality of channel electrodes during a driving period set according to the driving time signal.

The detecting of the phase may include amplifying the resonance signal, converting the amplified resonance signal from an analog signal to a digital signal, and detecting the phase of the digital signal.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a conceptual view of a coordinate measuring system according to an exemplary embodiment;

FIG. 2 is a schematic block diagram of a coordinate measuring device according to an exemplary embodiment;

FIG. 3 is a schematic block diagram of a coordinate indicating device according to an exemplary embodiment;

FIG. 4 is a block diagram of a resonance circuit of FIG. 3;

FIG. 5 is a circuit diagram of the resonance circuit of FIG. 4;

FIGS. 6A to 6G are graphs showing examples of a resonance signal output from a coordinate indicating device in a state where a driving frequency of a driving signal is fixed;

FIG. 7 is a block diagram of a coordinate measuring device according to an exemplary embodiment;

FIG. 8 is a block diagram of a coordinate measuring device according to an exemplary embodiment;

FIG. 9 is a block diagram of a sensor according to an exemplary embodiment;

FIG. 10 is a block diagram showing an example of the sensor of FIG. 9;

FIGS. 11A to 11D are block diagrams of detectors according to one or more exemplary embodiments;

FIGS. 12A to 12C are graphs showing a waveform of a driving signal, a waveform of a resonance signal in a case where a driving frequency and a resonance frequency are different from each other, and a waveform of a resonance signal in a case where a driving frequency is equal to a resonance frequency;

FIGS. 13A and 13B are graphs showing a waveform of a driving signal and a waveform of a resonance signal when a phase of the driving signal is different from a phase of the resonance signal;

FIGS. 14A and 14B are graphs showing a waveform of a driving signal and a waveform of a resonance signal when a phase of the driving signal is the same as a phase of the resonance signal, according to an exemplary embodiment;

FIG. 15A to FIG. 15G are graphs showing examples of a resonance signal output from a coordinate indicating device in a case where a driving frequency of a driving signal and a driving phase are adjusted adaptively to the resonance signal;

FIG. 16 is a block diagram of a coordinate measuring device according to an exemplary embodiment;

FIG. 17 is a block diagram of a coordinate measuring device according to an exemplary embodiment;

FIG. 18 is a flowchart illustrating a method of measuring coordinates, according to an exemplary embodiment; and

FIG. 19 is a flowchart illustrating a method of measuring coordinates, according to an exemplary embodiment.

### DETAILED DESCRIPTION

The following descriptions and accompanying drawings are provided to appreciate the operation of the exemplary embodiments, and known elements may be omitted.

The specification and drawings are not provided to limit the exemplary embodiments to particular modes of practice, and the scope of the exemplary embodiments is defined by appended claims. Terms used herein have to be interpreted to have meanings and concepts corresponding to technical gist of the inventive concept so as to appropriately represent the inventive concept. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more exemplary embodiments will be described below with reference to accompanying drawings.

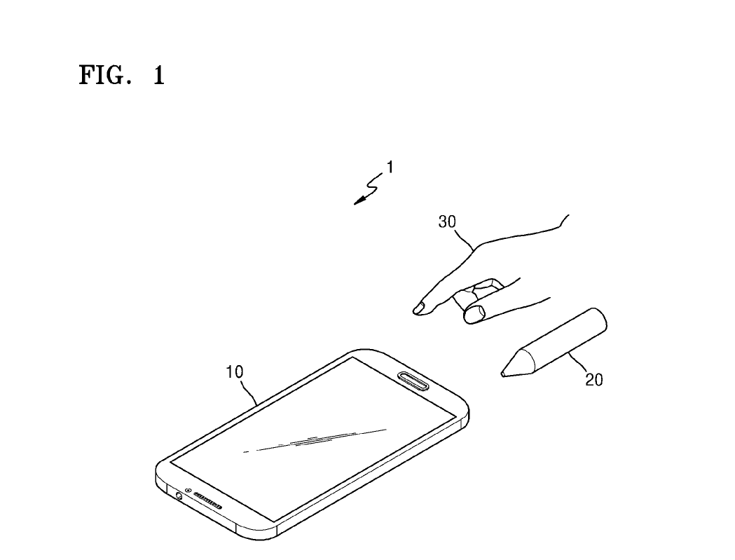

FIG. 1 is a conceptual view of a coordinate measuring system 1 according to an exemplary embodiment.

Referring to FIG. 1, the coordinate measuring system 1 includes a coordinate measuring device 10 and a coordinate indicating device 20. The coordinate measuring device 10 may measure a coordinate of an input location by detecting information about a location on the coordinate indicating device 20 or a touch input. Also, the coordinate measuring device 10 may measure a coordinate of the input location by detecting a contact location of a body part of a user, e.g., a finger 30.

The coordinate measuring device 10 is a device including a touch screen capable of receiving a touch input, and may be referred to as a touch input device. The coordinate measuring device 10 may be any kind of device that may receive a touch input generated by a contact of the coordinate indicating device 20 or a contact by the finger 30. For example, the coordinate measuring device 10 may be realized in various types, e.g., a smartphone, a tablet PC, a personal digital assistant (PDA), or a camera.

In general, a touch screen may operate based on an electrical method, an infrared ray method, and an ultrasonic method. Examples of the electrical type touch screen may include a resistive touch screen or a capacitive touch screen. The resistive touch screen may recognize a finger of a user and a stylus pen at the same time, but air layers between an indium tin oxide (ITO) layers may reflect light. In more detail, a transmittance of light emitted from a display degrades due to the air layers between the ITO layers, and reflection of external light may increase.

Accordingly, a capacitive type touch screen is mainly used, and the capacitive touch screen operates by sensing a difference between capacitances of a transparent electrode, wherein the difference between the capacitances is caused by a contact of an object. However, it is difficult to distinguish a finger of the user from a stylus pen physically by using the capacitive touch screen, and thus, an operating error may occur due to an unintended contact of the hand if the user uses a stylus pen to generate a touch input.

In order to address the above problems, a method of using software for distinguishing the user's hand from the stylus pen according to a contact area and a contact shape and a method of using an additional location measuring device, e.g., an electromagnetic resonance (EMR) method, have been used. However, the method of using the software may not completely address the operating error caused by the unintended contact of the hand. In addition, the method of using the additional location measuring device may increase a volume of the electronic device, a weight of the electronic device, and manufacturing costs of the electronic device due to added components. Accordingly, a technology of determining a touch input without causing an operating error in a case where a touch input is made by using an object such as a stylus pen without adding an additional location measuring device needs to be developed.

The coordinate measuring device 10 according to the exemplary embodiment may sense a touch of a conductive object such as a finger in a capacitive way, and the coordinate indicating device 20 may provide the coordinate measuring device 10 with a coordinate input, that is, a touch input, by contacting the touch screen of the coordinate measuring device 10. In detail, the coordinate indicating device 20 may include a conductive contact portion, and when the conductive contact portion contacts the touch screen of the coordinate measuring device 10, the coordinate indicating device 20 may designate a certain coordinate on the touch screen. However, one or more exemplary embodiments are not limited thereto, that is, the coordinate indicating device 20 may provide the coordinate measuring device 10 with the coordinate input by being in close proximity to the touch screen of the coordinate measuring device 10, without directly contacting the touch screen.

The coordinate indicating device 20 may be formed as a stylus pen, and may have a contact area that is relatively smaller than that of the finger 30. However, the shape of the coordinate indicating device 20 may vary, for example, and may be an education tool, a doll, or a toy.

The coordinate measuring device 10 may measure an input location of a contact object that provides the touch input, and may classify a type of the contact object. Here, the contact object may be a body part of the user, e.g., the finger 30, or the coordinate indicating device 20 such as the stylus pen. The coordinate measuring device 10 may measure an input location of the contact object 20 or 30. The coordinate measuring device 10 may measure the location of the contact object 20 or 30 based on variation in a capacitance, which is caused by the contact of the contact object 20 or 30. Otherwise, the coordinate measuring device 10 may measure the location of the coordinate indicating device 20 based on a magnitude of a resonance signal generated by the coordinate indicating device 20.

Next, the coordinate measuring device 10 may recognize a type of the contact object 20 or 30. If the contact object is the coordinate indicating device 20, the coordinate measuring device 10 may receive identification information from the coordinate indicating device 10. In particular, the coordinate measuring device 10 may transmit a driving signal Tsig to the coordinate indicating device 20 and may determine the kind of the contact object based on a frequency response characteristic of the coordinate indicating device 20 with respect to the driving signal Tsig.

When receiving a certain frequency response signal with respect to the driving signal Tsig, the coordinate measuring device 10 may determine that the contact object is the coordinate indicating device 20. In addition, if the coordinate measuring device 10 may not receive a certain frequency response signal with respect to the driving signal Tsig, the coordinate measuring device 10 may determine that the contact object is a body part of the user, e.g., the finger 30 of the user.

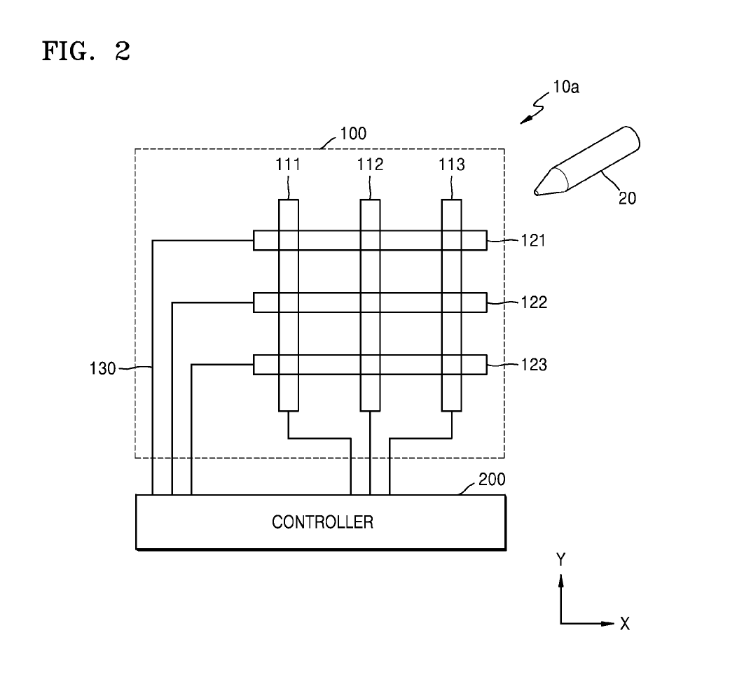

FIG. 2 is a schematic block diagram of a coordinate measuring device 10a according to an exemplary embodiment.

Referring to FIG. 2, the coordinate measuring device 10a may include a panel 100 and a controller 200. Although not shown in FIG. 2, the coordinate measuring device 10a may further include an image display unit such as a liquid crystal display (LCD) or an organic light emitting diode (OLED), or a protective window. The coordinate measuring device 10a according to the exemplary embodiment is an example of the coordinate measuring device 10 illustrated with reference to FIG. 1, and the above descriptions with reference to FIG. 1 may be applied to the coordinate measuring device 10a according to the exemplary embodiment. Therefore, the coordinate measuring device 10a may measure an input location of the coordinate indicating device 20.

The panel 10 may include a plurality of channel electrodes 111 to 113 and 121 to 123. The channel electrodes 111 to 113 and 121 to 123 may be electrically connected to the controller 200 via connecting wires 130 respectively corresponding thereto. For example, the plurality of channel electrodes 111 to 113 and 121 to 123 may be formed of indium tin oxide (ITO).

In FIG. 2, the panel 100 includes six channel electrodes 111 to 113 and 121 to 123, but the panel 100 may further include the channel electrodes greater than six according to one or more exemplary embodiments. Also, in FIG. 2, the plurality of channel electrodes 111 to 113 and 121 to 123 are formed as rectangular shapes, but the channel electrodes may have various shapes.

According to the exemplary embodiment, the plurality of channel electrodes 111 to 113 and 121 to 123 may be arranged to cross each other at right angles. In detail, first channel electrodes 111 to 113 arranged in parallel with each other in a first direction (e.g., Y-axis direction) are electrodes for measuring a location in a second direction (e.g., X-axis direction) crossing the first direction at a right angle, and second channel electrodes 121 to 123 arranged in parallel with each other in the second direction are electrodes for measuring a location in the first direction that crosses the second direction at a right angle.

In the exemplary embodiment, the second channel electrodes 121 to 123 are transmitting and receiving electrodes, and the first channel electrodes 111 to 113 may be receiving electrodes. The second channel electrodes 121 to 123 may transmit an electrical signal generated by the controller 200 to outside in a transmitting mode, and may receive an electrical signal input from outside and transfer the electrical signal to the controller 200 in a receiving mode.

At least one of the plurality of second channel electrodes 121 to 123 may transmit the driving signal Tsig to the coordinate indicating device 20 for resonating the coordinate indicating device 20 through a capacitive coupling with the coordinate indicating device 20. In more detail, at least one of the plurality of second channel electrodes 121 to 123 may transmit the driving signal Tsig from the controller 200 to the coordinate indicating device 20. The coordinate indicating device 20 receives the driving signal Tsig to obtain energy that is necessary for performing resonance.

Also, at least one selected from the plurality of first and second channel electrodes 111 to 113, and 121 to 123 may receive a resonance signal Rsig generated by the coordinate indicating device 20 through a capacitive coupling with the coordinate indicating device 20. At least one selected from the plurality of first and second channel electrodes 111 to 113 and 121 to 123 may receive the resonance signal Rsig from the coordinate indicating device 20, and transmit the resonance signal Rsig to the controller 200.

The controller 200 may sense at least one of a frequency and a phase of the resonance signal Rsig, and may adjust the driving signal Tsig adaptively to the at least one of the frequency and the phase. In one exemplary embodiment, the controller 200 may adjust a driving frequency of the driving signal Tsig to be identical to the sensed frequency. In another exemplary embodiment, the controller 200 may adjust a driving phase of the driving signal Tsig to be identical to the sensed phase. In another exemplary embodiment, the controller 200 may determine a driving time of the driving signal Tsig according to the sensed phase.

Also, the controller 200 may sense a location of the coordinate indicating device 20, and in particular, may determine an input location of the coordinate indicating device 20. In detail, the controller 200 may determine a coordinate in the X-axis direction, which correspond to one of the first channel electrodes 111 to 113 having the largest variation in an intensity of the resonance signal Rsig, as an X-axis coordinate of the input location of the coordinate indicating device 20. Also, the controller 200 may determine a Y-axis coordinate corresponding one of the second channel electrodes 121 to 123, which receives the driving signal Tsig during a period in which the variation in the intensity of the resonance signal Rsig is the largest, as a Y-axis coordinate of the input location of the coordinate indicating device 20. However, one or more exemplary embodiments are not limited thereto, that is, in another exemplary embodiment, the controller 200 may determine the coordinate of the input location based on an interpolation or other algorithms based on the variation in the intensity of the resonance signal Rsig in each period.

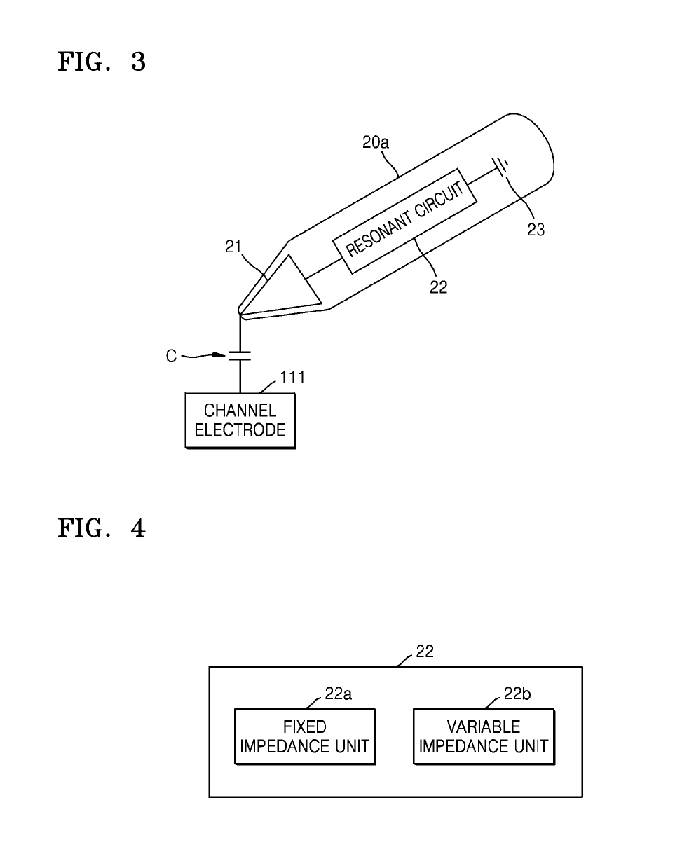

FIG. 3 is a schematic block diagram of an example of a coordinate indicating device 20a according to an exemplary embodiment.

Referring to FIG. 3, the coordinate indicating device 20a may include a conductive contact portion and a resonance circuit 22. The coordinate indicating device 20a according to the exemplary embodiment does not include an additional internal power source, but may operate in a passive manner. However, one or more exemplary embodiments are not limited thereto, that is, in another exemplary embodiment, the coordinate indicating device 20a may further include an internal power source such as a battery. In the exemplary embodiment, the coordinate indicating device 20a may be formed as a pen, but is not limited thereto.

The conductive contact portion 21 may have a capacitance C by forming a capacitive coupling with at least one of the plurality of channel electrodes included in the coordinate measuring device (e.g., 10a of FIG. 2), for example, the channel electrode 111. The conductive contact portion 21 may be formed as, for example, a metal tip, and accordingly, may be also referred to as a conductive tip. The conductive contact portion 21 may be disposed in a non-conductive material so that a part of the conductive contact portion 21 is exposed to an outside of the coordinate indicating device 20a.

The resonance circuit 22 is connected between the conductive contact portion 21 and a ground terminal 23, and may obtain energy that is necessary for the resonance based on the driving signal Tsig transmitted from the coordinate measuring device 10a through the capacitive coupling C. The resonance circuit 22 may generate the resonance signal Rsig based on the obtained energy, and the resonance signal Rsig may be output as a sine wave form having a certain resonant frequency. The resonance frequency of the resonance signal Rsig may be used as identification information of the coordinate indicating device 20a. In the exemplary embodiment, the resonant frequency of the resonance signal Rsig may vary depending on a pen pressure.

FIG. 4 is a block diagram of the resonance circuit 22 of FIG. 3 in more detail.

Referring to FIG. 4, the resonance circuit 22 may include a fixed impedance unit 22a and a variable impedance unit 22b. The fixed impedance unit 22a may include a fixed capacitor Cf having a fixed capacitance and a fixed inductor Lf having a fixed inductance, so as to output a resonance signal having an exclusive resonant frequency.

The variable impedance unit 22b may have an impedance that is variable according to at least one of a contact pressure and whether to contact. In more detail, the variable impedance unit 22b may generate an impedance that varies depending on a pen pressure, and accordingly, may be referred to as a pen pressure detector. The variable impedance unit 22b may include at least one selected from a variable capacitor Cv, a variable inductor Lv, and a variable resistor Rv.

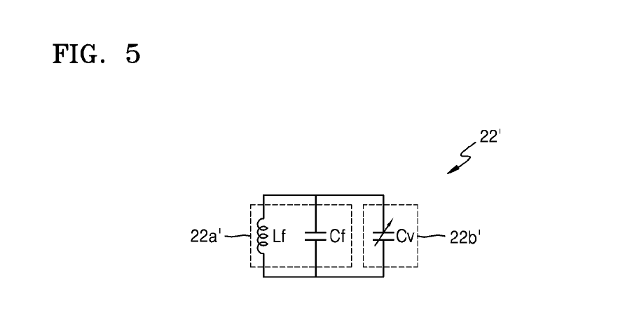

FIG. 5 is a circuit diagram of the resonance circuit 22 of FIG. 4.

Referring to FIG. 5, a fixed impedance unit 22a′ may include a fixed capacitor Cf and a fixed inductor Lf that are connected in parallel. In another exemplary embodiment, the fixed impedance unit 22a′ may further include a resistor that is connected thereto in series or in parallel.

A variable impedance unit 22b′ may include a variable capacitor Cv having a capacitance that varies depending on the pen pressure. However, the variable impedance unit 22b′ may include a variable inductor Lv having an inductance that varies depending on the pen pressure. In another exemplary embodiment, the variable impedance unit 22b′ may further include a variable resistor that is connected in series or in parallel.

Hereinafter, operations of the coordinate measuring device 10a and the coordinate indicating device 20a will be described below with reference to FIGS. 2 to 5.

When the coordinate indicating device 20a contacts or approaches the coordinate measuring device 10a, the conductive contact portion 21 forms a capacitive coupling with the channel electrode 111 and receives the driving signal Tsig from the channel electrode 111 via the capacitive coupling. That is, the coordinate indicating device 20a may acquire energy that is necessary for the resonance from the coordinate measuring device 10a through the capacitive coupling. Therefore, the coordinate indicating device 20a does not need to include an additional battery, and thus, the user is not inconvenienced by replacing the battery, such that maintenance costs and a volume of the device may be reduced.

In addition, the resonance circuit 22 that is electrically connected to the conductive contact portion 21 may generate the resonance signal Rsig based on the obtained energy, and the resonance signal Rsig may be provided to the coordinate measuring device 10a via the capacitive coupling between the conductive contact portion 21 and the channel electrode 111. Here, the resonance circuit 22 may generate the resonance signal having a resonant frequency that varies depending on the pen pressure.

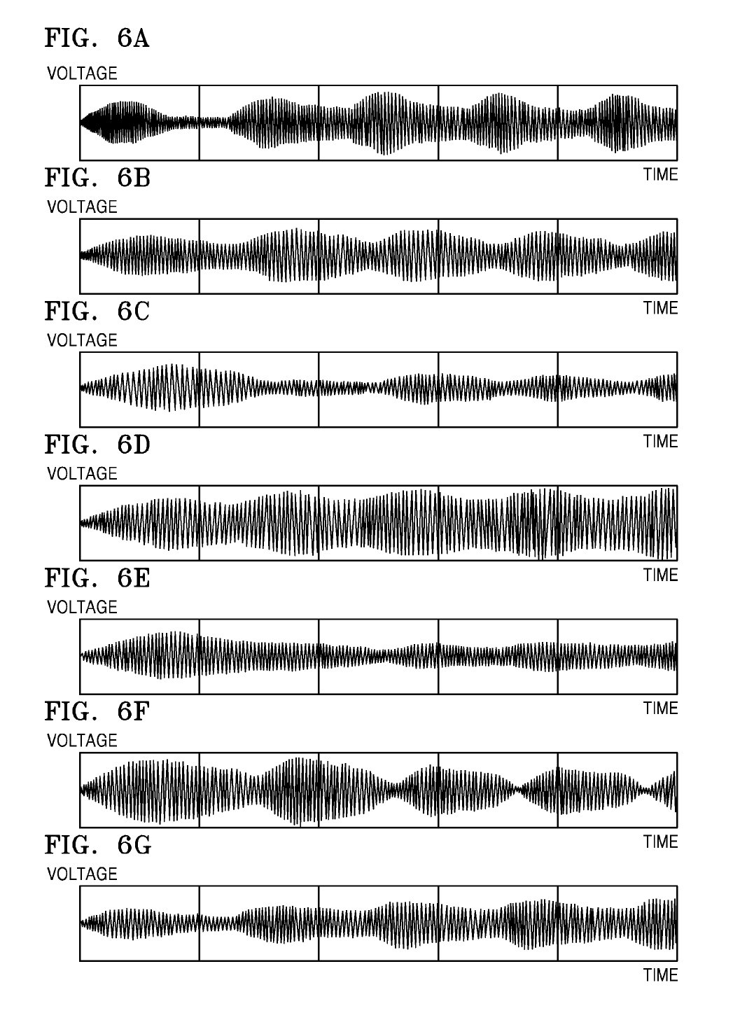

FIGS. 6A to 6G are graphs showing examples in which the resonant frequency of the resonance signal Rsig varies in a state where the driving frequency of the driving signal Tsig is fixed.

Referring to FIGS. 6A to 6G, a horizontal axis denotes time and a longitudinal axis denotes voltage, that is, an intensity of the resonance signal Rsig. Here, the driving signal Tsig has a driving frequency fd that is fixed as a constant value without regard to the resonant frequency of the resonance signal Rsig. FIG. 6A shows a case where the resonance signal Rsig has a first resonant frequency fr1, FIG. 6B shows a case where the resonance signal Rsig has a second resonant frequency fr2, FIG. 6C shows a case where the resonance signal Rsig has a third resonant frequency fr3, FIG. 6D shows a case where the resonance signal Rsig has a fourth resonant frequency fr4, FIG. 6E shows a case where the resonance signal Rsig has a fifth resonant frequency fr5, FIG. 6F shows a case where the resonance signal Rsig has a sixth resonant frequency fr6, and FIG. 6G shows a case where the resonance signal Rsig has a seventh resonant frequency fr7. Here, the first to seventh resonant frequencies fr1 to fr7 may be different from one another.

In the example illustrated in FIG. 6D, the fourth resonant frequency fr4 may be equal to the driving frequency fd. As described above, if the fourth resonant frequency fr4 is equal to the driving frequency fd, it is easy to transfer the energy from the coordinate measuring device 10a to the coordinate indicating device 20a. Thus, the coordinate indicating device 20a may generate the resonance signal Rsig of a relatively large amplitude. In addition, the amplitude of the resonance signal Rsig becomes greater according to time lapse.

However, in the examples of FIGS. 6A to 6C and FIGS. 6E to 6G, the first to third resonant frequencies fr1 to fr3 and the fifth to seventh resonant frequencies fr6 to fr7 may be different from the driving frequency fd. In the examples illustrated in FIGS. 6C to 6E, since it is not easy to transfer the energy from the coordinate measuring device 10a to the coordinate indicating device 20a, the coordinate indicating device 20a may generate the resonance signal Rsig having a relatively small amplitude. In addition, the amplitude of the resonance signal Rsig may be smaller according to the time lapse. Also, in the examples of FIGS. 6B and 6F, since it is not easy to transfer the energy from the coordinate measuring device 10a to the coordinate indicating device 20a, the amplitude of the resonance signal Rsig may not gradually increase according to the driving signal, unlike in FIG. 6D. The scale of the longitudinal axes of FIGS. 6A to 6G are not equal to each other, and waveforms shown in FIGS. 6A to 6C and FIGS. 6E to 6G are much smaller than the waveform shown in FIG. 6D when they are shown in the same scale.

As described above, if the resonant frequency fr of the resonance signal Rsig generated by the coordinate indicating device 20a varies depending on the change in the pen pressure of the coordinate indicating device 20a, an efficiency of transmitting signals may degrade due to a difference between the driving frequency fd of the driving signal Tsig and the resonant frequency fr of the resonant signal Rsig. Accordingly, the amplitude of the resonant signal Rsig that the coordinate measuring device 10a receives may be reduced, and accordingly, accuracy and efficiency of measuring the coordinates in the coordinate measuring device 10a may be reduced and an operating error may occur.

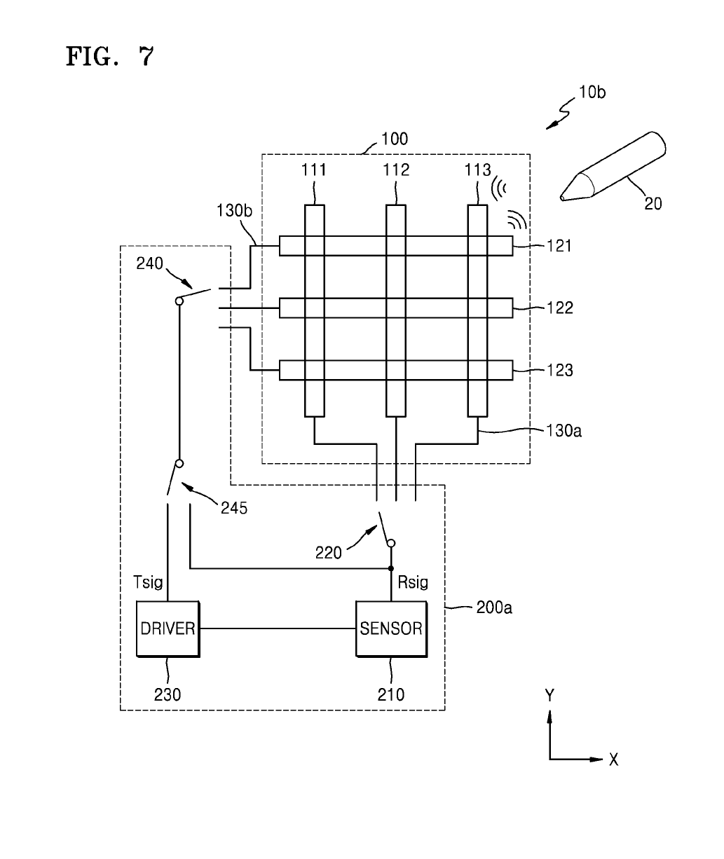

FIG. 7 is a block diagram of a coordinate measuring device 10b according to an exemplary embodiment.

Referring to FIG. 7, the coordinate measuring device 10b may include a panel 100 and a controller 200a, and the controller 200a may further include a sensor 210 and a driver 230. Also, the controller 200a may further include first to third control switches 220, 240, and 245. The coordinate measuring device 10b according to the exemplary embodiment is a modified example of the coordinate measuring device 10 of FIG. 1 and the coordinate measuring device 10a of FIG. 2, and the above descriptions with reference to FIGS. 1 and 2 may be also be applied to the coordinate measuring device 10b according to the exemplary embodiment. Therefore, overlapping descriptions will be described below.

The panel 100 may include the plurality of first electrodes 111 to 113 and the plurality of second channel electrodes 121 to 123. In the exemplary embodiment, the second channel electrodes 121 to 123 are arranged in parallel with each other in the second direction (e.g., X-axis direction), and may be used both as transmitting electrodes and receiving electrodes. The first channel electrodes 111 to 113 may be arranged in parallel with each other in the first direction (e.g., Y-axis direction), and may be used as only the receiving electrodes. As described above, when the plurality of first and second channel electrodes 111 to 113 and 121 to 123 are used as the receiving electrodes, a location of the coordinate indicating device 20 on a two-dimensional (2D) plane may be measured.

The first control switch 220 may control connections between the sensor 210 and the first channel electrodes 111 to 113 based on an order that is set in advance. The second control switch 240 may control connections between the second channel electrodes 121 to 123 and the third control switch 245 based on an order that is set in advance. The third control switch 245 may connect one of the second channel electrodes 121 to 123, which is connected thereto by the second control switch 240, to the sensor 210 or the driver 230, based on an order that is set in advance.

The driver 230 may provide the driving signal Tsig to one of the plurality of second channel electrodes 121 to 123 by switching operations of the second and third control switches 240 and 245. According to the exemplary embodiment, the driver 230 may be referred to as a transmitter. In more detail, the third control switch 245 may connect the driver 230 to the second control switch 240 during a driving period. Here, the second control switch 240 connected to the driver 230 may control the connection between the driver 230 and the plurality of second channel electrodes 121 to 123 based on the order that is set in advance. For example, the second control switch 240 may connect the second channel electrode 121 to the driver 230 during a first period, may connect the second channel electrode 122 to the driver 230 during a second period, and may connect the second channel electrode 123 to the driver 230 during a third period.

The sensor 210 may receive the resonance signal Rsig from one of the plurality of first and second channel electrodes 111 to 113 and 121 to 123 according to the switching operations of the first to third control switches 220, 240, and 245. According to the exemplary embodiment, the sensor 210 may be also referred to as a receiver. In more detail, the third control switch 245 may connect the sensor 210 to the second control switch 240 during a receiving period for the resonance signal Rsig. The first and second control switches 220 and 240 may control the connections between the sensor 210 and the plurality of first and second channel electrodes 111 to 113 and 121 to 123 based on an order that is set in advance. For example, the first control switch 220 may connect the first channel electrode 111 to the sensor 210 during a first period, may connect the first channel electrode 112 to the sensor 210 during a second period, and may connect the first channel electrode 113 to the sensor 210 during a third period.

Although not shown in the drawings, the controller 200a may further include a plurality of sensors respectively corresponding to the plurality of first and second channel electrodes 111 to 113 and 121 to 123, and each of the plurality of sensors may receive the resonance signals Rsig simultaneously from the plurality of first and second channel electrodes 111 to 113 and 121 to 123.

According to the exemplary embodiment, the sensor 210 may sense at least one of a frequency and a phase of the resonance signal Rsig that is transmitted from at least one of the plurality of first and second channel electrodes 111 to 113 and 121 to 123, and may output information about the at least one of the frequency and the phase, which is sensed. In the exemplary embodiment, the sensor 210 transforms the resonance signal Rsig from a temporal domain to a frequency domain, and may detect a resonant frequency fr from the resonance signal that is transformed to the frequency domain and a phase φr of the resonance signal Rsig. For example, the sensor 210 may include a digital signal processor (DSP).

Also, the driver 230 may adjust at least one of the frequency fd and a phase φd of the driving signal Tsig to adapt to the at least one of the frequency fr and the phase φr that is output, and may provide the driving signal Tsig that is adjusted to at least one of the plurality of second channel electrodes 121 to 123. Therefore, the adjusted driving frequency fd of the driving signal Tsig may be equal to the resonant frequency fr of the resonance signal Rsig, or the adjusted driving phase φd of the driving signal Tsig may be equal to the phrase φr of the resonance signal Rsig.

As described above, according to the exemplary embodiment, even when the resonant frequency of the resonance signal Rsig generated by the coordinate indicating device 20 varies due to the change in the pen pressure of the coordinate display device 20, the controller 200a included in the coordinate measuring device 10b may detect the changed resonant frequency or the changed phase of the resonance signal Rsig and may adjust the frequency or the phase of the driving signal Tsig adaptively to the changed resonant frequency or the changed phase. Accordingly, the energy may be easily transferred to the coordinate measuring device 10b to the coordinate indicating device 20, and the amplitude of the resonance signal Rsig generated by the coordinate indicating device 20 may be stably increased according to the time lapse. Therefore, the sensitivity of the resonance signal Rsig may be improved, and accuracy and efficiency of the measuring operation in the coordinate measuring device 10b may be improved.

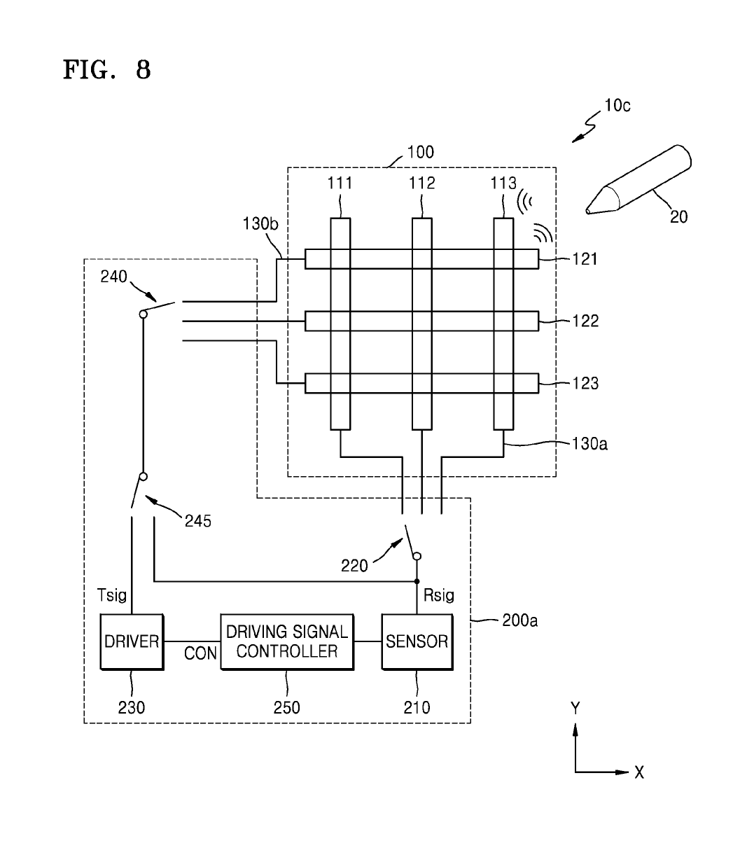

FIG. 8 is a block diagram of a coordinate measuring device 10c according to an exemplary embodiment.

Referring to FIG. 8, the coordinate measuring device 10c may include the panel 100 and a controller 200b, and the controller 200b may include the sensor 210, the driver 230, and a driving signal controller 250. Also, the controller 200b may further include the first to third control switches 220, 240, and 245. The coordinate measuring device 10c according to the exemplary embodiment is a modified example of the coordinate measuring device 10b of FIG. 7, and thus, descriptions with reference to FIG. 7 may be applied to the coordinate measuring device 10c of FIG. 8. Therefore, descriptions that are the same as the above descriptions with reference to FIG. 7 will be omitted below.

In the present exemplary embodiment, the sensor 210 senses at least one of the frequency fr and the phase φr of the resonance signal Rsig transmitted from at least one of the plurality of first and second channel electrodes 111 to 113 and 121 to 123, and may output information about the at least one of the frequency fr and the phase φr, which is sensed. In one exemplary embodiment, the sensor 210 transforms the resonance signal Rsig from a temporal domain to a frequency domain, and detects the resonant frequency fr and the phase φr from the resonance signal Rsig that is transformed to the frequency domain. For example, the sensor 210 may include a DSP.

The driving signal controller 250 may generate a control signal CON that controls at least one of the driving frequency fd and the driving phase φd of the driving signal Tsig according to the output information about at least one of the frequency fr and the phase φr. For example, the driving signal controller 250 may be formed as a micro controller unit (MCU).

The driver 230 adjusts at least one of the driving frequency fd and the driving phase φd of the driving signal Tsig adaptively to the generated control signal CON, and may provide the driving signal Tsig to one of the plurality of second channel electrodes 121 to 123. Therefore, the driving frequency fd of the driving signal Tsig may be equal to the resonant frequency fr of the resonance signal Rsig, or the driving phase φd of the driving signal Tsig may be equal to the phase φr of the resonance signal Rsig.

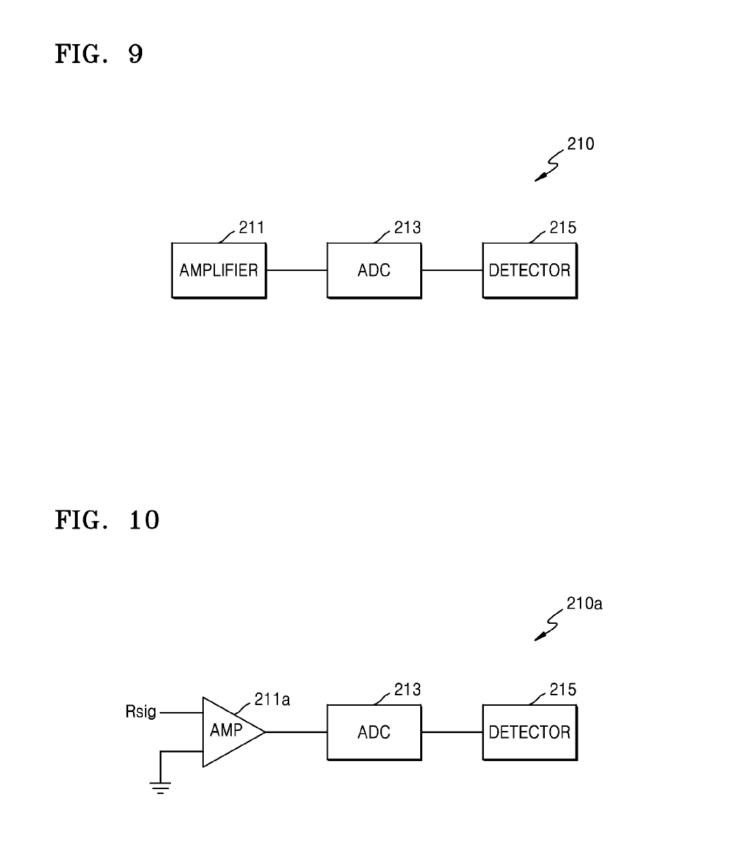

FIG. 9 is a block diagram of the sensor 210 according to the exemplary embodiment.

Referring to FIG. 9, the sensor 210 may include an amplifier 211, an analog to digital converter (ADC) 213, and a detector 215.

The amplifier 211 may amplify the resonance signal Rsig and output an amplified resonance signal. The ADC 213 may convert the amplified resonance signal to a digital signal. The detector 215 may detect at least one of the frequency and the phase from the converted digital signal. The detector 215 may detect at least one of the resonant frequency fr of the resonance signal Rsig and the phase φd of the resonance signal Rsig by performing at least one selected from a Fourier transformation, a fast Fourier transformation (FFT), and a discrete Fourier transformation (DFT) with respect to the digital signal.

FIG. 10 is a block diagram of an example (210a) of the sensor 210 of FIG. 9.

Referring to FIG. 10, an amplifier 211a has a first input terminal receiving the resonance signal Rsig and a second input terminal connected to a ground terminal, and amplifies the resonance signal Rsig by a predetermined ratio to output the resonance signal that is amplified. However, one or more exemplary embodiments are not limited thereto, that is, the amplifier 211a may be modified variously.

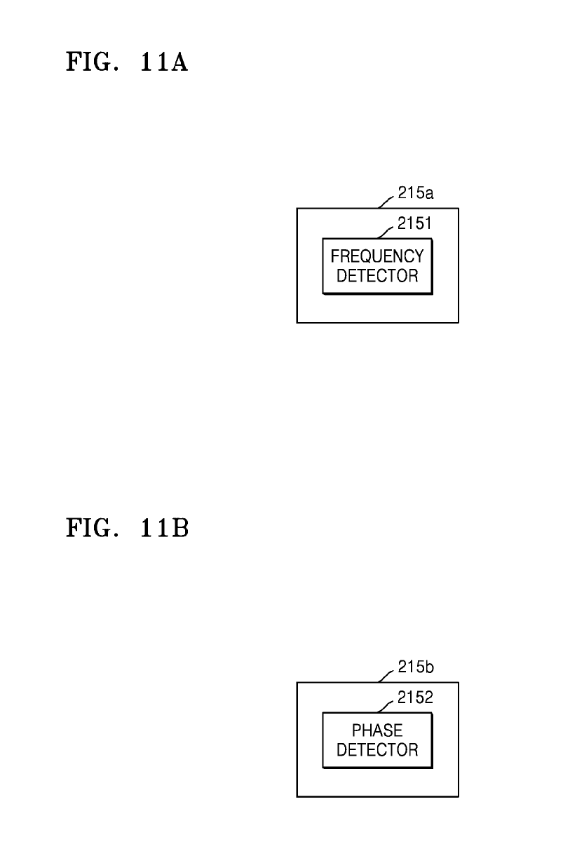

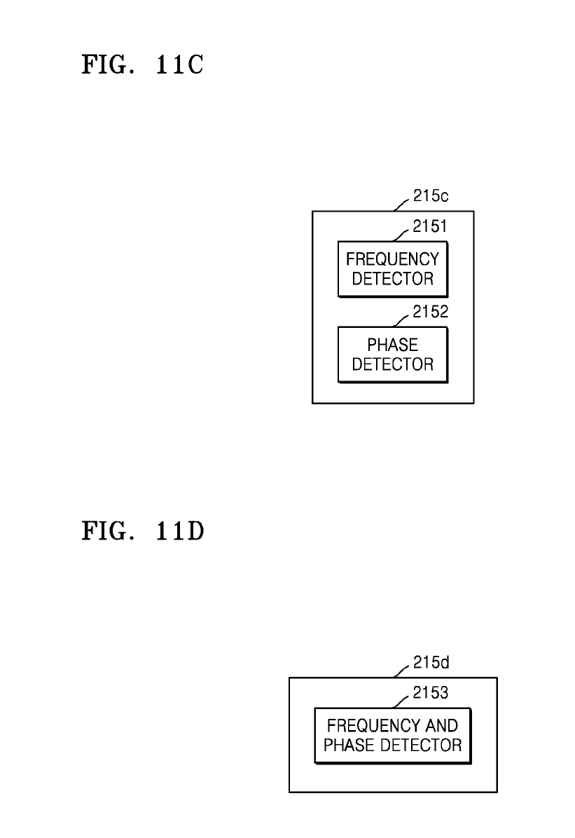

FIGS. 11A to 11D are block diagrams of detectors 215a to 215d according to exemplary embodiments.

Referring to FIG. 11A, the detector 215a may include a frequency detector 2151. The frequency detector 2151 detects the resonant frequency fr of the resonance signal Rsig, and may provide the detected resonant frequency fr to the driver 230 or the driving signal controller 250.

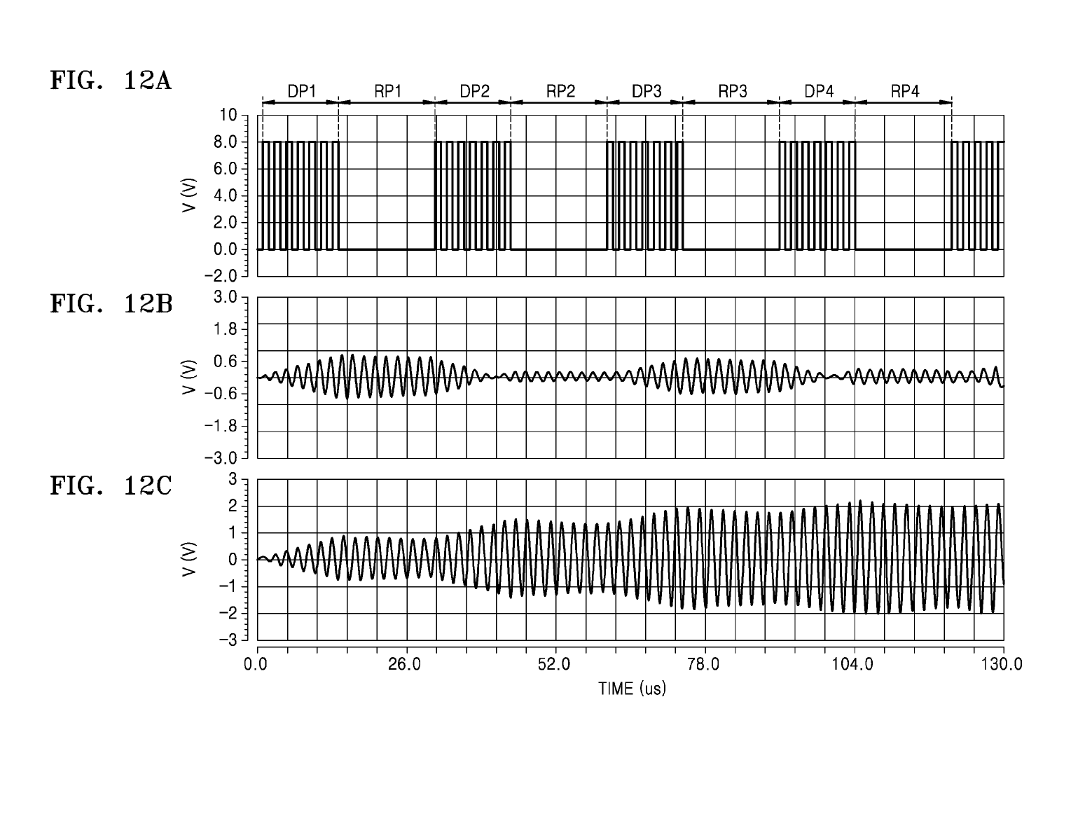

FIGS. 12A to 12C are graphs showing a waveform of a driving signal, a waveform of a resonance signal in a case where a driving frequency and a resonance frequency are different from each other, and a waveform of a resonance signal in a case where a driving frequency and a resonance frequency are equal to each other.

Referring to FIGS. 12A to 12C, a horizontal axis denotes time and a longitudinal axis denotes an intensity of a signal indicated in a voltage. FIG. 12A shows the driving signal Tsig having the driving frequency fd. The driver (e.g., 230 of FIG. 7) outputs the driving signal Tsig during a driving period DP, and may not output the driving signal Tsig during a reset period RP. In more detail, the driving signal Tsig may be output as a square wave signal having the driving frequency fd.

FIG. 12B denotes a case where the driving frequency fd and the resonant frequency fr are different from each other. In first and third driving periods DP1 and DP3, an amplitude of the resonance signal Rsig increases according to time, but in second and fourth driving periods DP2 and DP4, the amplitude of the resonance signal Rsig decreases according to time. Accordingly, it is difficult to constantly increase the amplitude of the resonance signal Rsig according to time. The example shown in FIG. 12B is obtained when a difference between the driving frequency fd and the resonant frequency fr is less than a threshold value, and if the difference between the driving frequency fd and the resonant frequency fr is larger than the threshold value, the resonance signal Rsig may not be generated.

FIG. 12C shows a case where the driving frequency fd and the resonant frequency fr are equal to each other. In first to fourth driving periods DP1 to DP4, the amplitude of the resonance signal Rsig increases according to time. In addition, in first to fourth reset periods RP1 to RP4, the amplitude of the resonance signal Rsig decreases according to time. Accordingly, the variation in the amplitude of the resonance signal Rsig may be predicted according to a length of the driving period, a length of the reset period, and the number of the driving periods, to easily adjust the resonance signal Rsig. A reduction ratio of the resonance signal Rsig during the reset period RP may be determined by a resistor in the resonance circuit 22 or an external coupling loss. Therefore, according to the exemplary embodiment, in a case where the frequency of the resonance signal is measured and the driving signal is generated to have the frequency that is equal to the frequency of the resonance signal, a magnitude of the resonance signal may be stably ensured regardless of the variation in the frequency of the resonance signal caused by the variation in the pen pressure.

Referring to FIG. 11B, the detector 215b may include a phase detector 2152. The phase detector 2152 detects the phase φr of the resonance signal Rsig, and may provide the phase φr to the driver 230 or the driving signal controller 250.

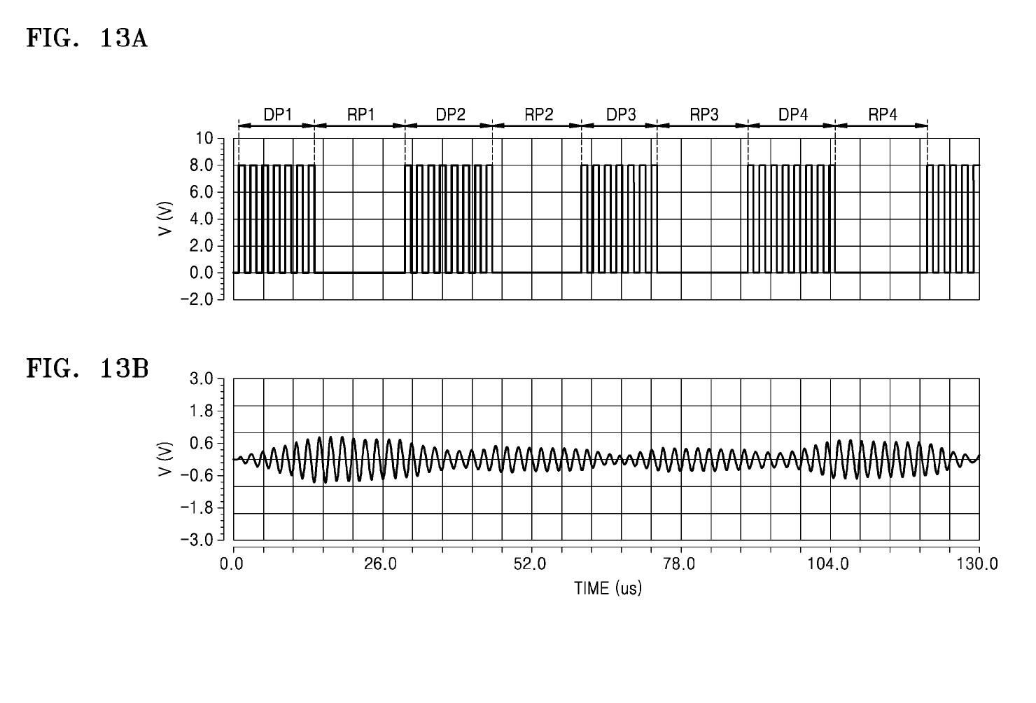

FIGS. 13A and 13B are graphs showing a waveform of a driving signal and a waveform of a resonance signal, respectively, when a phase of the driving signal is different from a phase of the resonance signal.

Referring to FIGS. 13A and 13B, a horizontal axis denotes time and a longitudinal axis denotes an intensity of a signal indicated in voltage. FIG. 13A shows the driving signal Tsig having the driving frequency fd. The driver (e.g., 230 of FIG. 7) outputs the driving signal Tsig during the driving period DP, and may not output the driving signal Tsig during the reset period RP. The driving signal Tsig may be output as a square wave signal having the driving frequency fd.

FIG. 13B shows a case where the driving signal Tsig and the resonance signal Rsig are out of phases with each other. Here, it is assumed that the phases of the driving signal Tsig and the resonance signal Rsig are compared with each other at a start point of the second driving period DP2. In this case, the variation pattern in the amplitude of the resonance signal Rsig is inconsistent, that is, the amplitude of the resonance signal Rsig may increase according to time in the driving period DP or may decrease in some cases. As described above, if the driving signal Tsig and the resonance signal Rsig are out of phase, it is difficult to constantly increase the amplitude of the resonance signal Rsig according to time due to destructive interference.

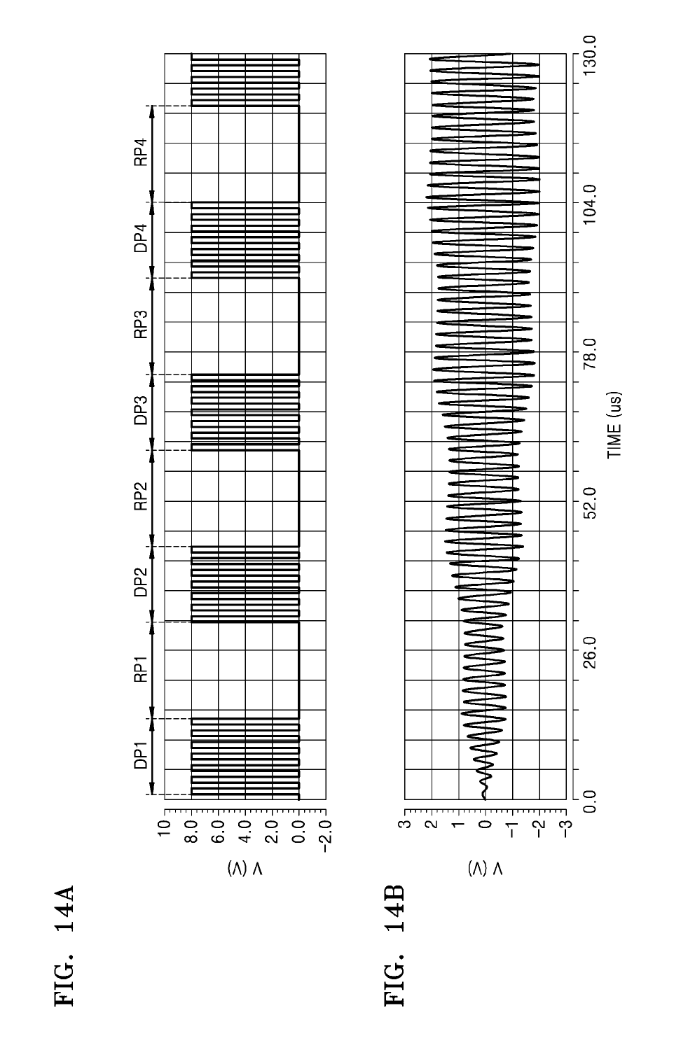

FIGS. 14A and 14B are graphs showing a waveform of the driving signal Tsig and a waveform of the resonance signal Rsig, respectively, when the phase of the driving signal and the phase of the resonance signal are equal to each other, according to an exemplary embodiment.

Referring to FIGS. 14A and 14B, a horizontal axis denotes time and a longitudinal axis denotes an intensity of a signal indicated in voltage. FIG. 14A shows the driving signal Tsig having the driving frequency fd. In the exemplary embodiment, the driving phase φd of the driving signal Tsig may be adjusted adaptively to the phase φr of the resonance signal Rsig output from the detector 215b of FIG. 11B. The driver 230 (see FIG. 7) may output the driving signal Tsig during the driving period DP, and may not output the driving signal Tsig during the reset period RP. In more detail, the driving signal Tsig may be output as a square wave signal having the driving frequency fd.

FIG. 14B shows a case where the driving signal Tsig and the resonance signal Rsig are in phases with each other. Here, the amplitude of the resonance signal Rsig increases according to time in very driving period DP and decreases according to time in every reset period RP. Accordingly, the variation in the amplitude of the resonance signal Rsig according to the length of the driving period, the length of the reset period, and the number of driving periods is predictable, and thus, it is easy to adjust the resonance signal Rsig. Here, a reduction ratio of the resonance signal Rsig during the reset period RP may be determined by the resistor in the resonance circuit 22 or the external coupling loss. Therefore, according to the exemplary embodiment, if the phase of the resonance signal Rsig is measured and the driving signal is generated having the same phase as that of the resonance signal Rsig, a stable magnitude of the resonance signal may be ensured regardless of the variation in the frequency of the resonance signal Rsig caused by the change in the pen pressure.

Referring to FIG. 11C, the detector 215c may include the frequency detector and the phase detector 2152. The frequency detector 2151 detects the resonant frequency fr of the resonance signal Rsig and provides the resonant frequency fr to the driver 230 or the driving signal controller 250. The phase detector 2152 detects the phase φr of the resonance signal Rsig, and provides the phase φr to the driver 230 or the driving signal controller 250.

Referring to FIG. 11D, the detector 215d may include a frequency and phase detector 2153. The frequency and phase detector 2153 detects the resonant frequency fr and the phase φr of the resonance signal Rsig, and provides the resonant frequency and the phase φr to the driver 230 or the driving signal controller 250. As described above, the frequency detection and the phase detection may be sequentially or simultaneously performed by using separate functional blocks, or may be sequentially or simultaneously performed by using one functional block.

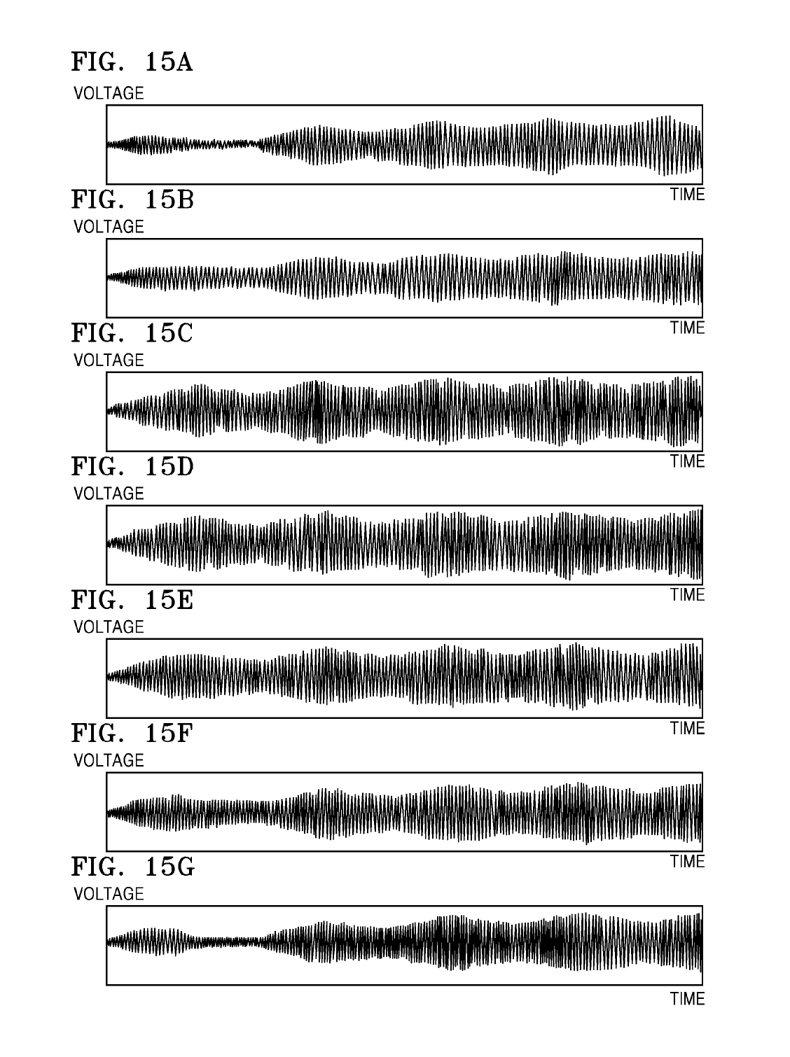

FIGS. 15A to 15G are graphs showing examples of the resonance signal Rsig output from the coordinate indicating device 20a, in a case where the driving frequency and the driving phase of the driving signal are adjusted adaptively to the resonance signal, according to an exemplary embodiment.

Referring to FIGS. 15A to 15G, a horizontal axis denotes time and a longitudinal axis denotes an intensity of the resonance signal Rsig in a voltage unit. According to the exemplary embodiment, the driving frequency fd and the driving phase φd of the driving signal Tsig may be adjusted adaptively to the resonant frequency fr and the phase φr of the resonance signal Rsig output from the detector 215c of FIG. 11C or the detector 215d of FIG. 11D. FIG. 15A shows a case where the resonance signal Rsig has a first resonant frequency fr1, FIG. 15B shows a case where the resonance signal Rsig has a second resonant frequency fr2, FIG. 15C shows a case where the resonance signal Rsig has a third resonant frequency fr3, FIG. 15D shows a case where the resonance signal Rsig has a fourth resonant frequency fr4, FIG. 15E shows a case where the resonance signal Rsig has a fifth resonant frequency fr5, FIG. 15F shows a case where the resonance signal Rsig has a sixth resonant frequency fr6, and FIG. 15G shows a case where the resonance signal Rsig has a seventh resonant frequency fr7. Here, the first to seventh resonant frequencies fr1 to fr7 may be different from one another. When the resonant frequency is changed, at the point where the driving signal Tsig starts, that is, the phase of the resonance signal Rsig varies depending on the frequency.

As described above, even when the first to seventh resonant frequencies fr1 to fr7 are different from one another, the driving frequency fd and the driving phase φd of the driving signal Tsig may be adjusted to adapt or correspond to the resonant frequencies to easily transfer the energy from the coordinate measuring device to the coordinate indicating device. Therefore, the coordinate indicating device may generate the resonance signal Rsig having a relatively large amplitude, and the amplitude of the resonance signal Rsig increases according to time. Accordingly, a signal to noise ratio (SNR) sensed by the sensor 210 is improved, and the accuracy of measuring the coordinate by the coordinate measuring device and the operating error may be reduced. Also, if the SNR of the signal increases and a sufficient SNR may be ensured, a magnitude of the driving signal Tsig may be reduced in order to reduce power consumption. Therefore, according to the exemplary embodiment, the frequency and the phase of the resonance signal are measured and the driving signal is generated to have the frequency and the phase that are equal to those of the resonance signal, and then, a stable magnitude of the resonance signal may be ensured regardless of the variation in the frequency of the resonance signal due to the variation in the pen pressure.

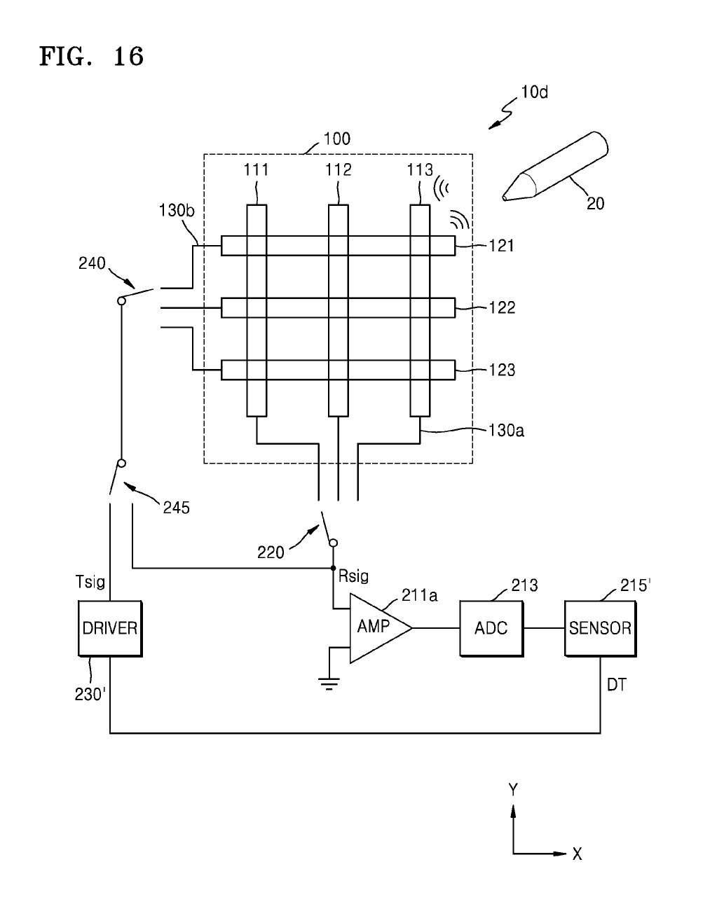

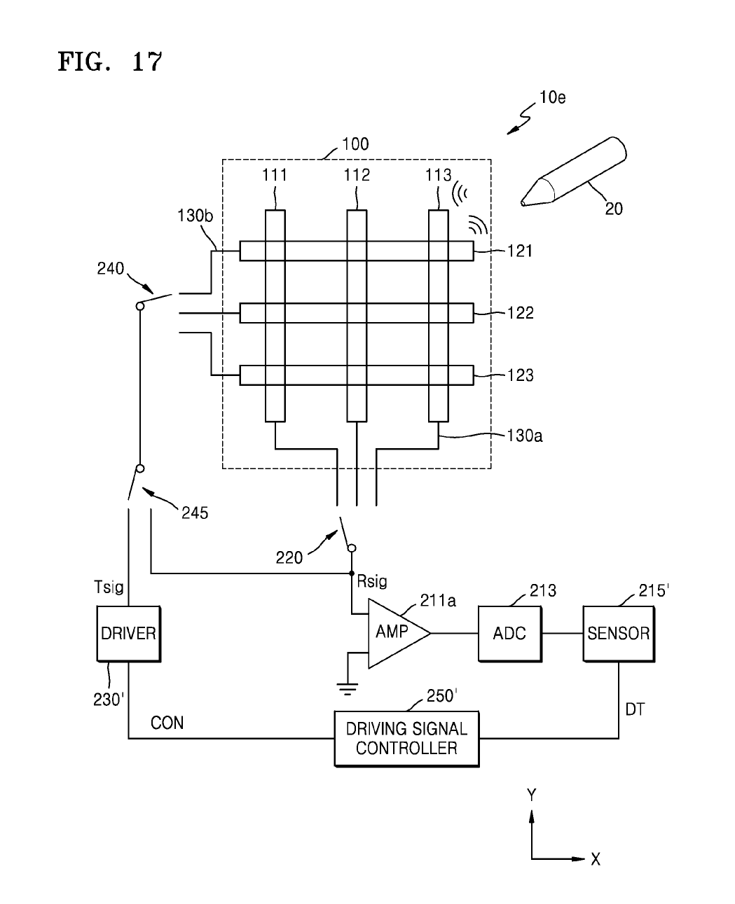

FIG. 16 is a block diagram of a coordinate measuring device 10d according to an exemplary embodiment.

Referring to FIG. 16, the coordinate measuring device 10d includes the panel 100, an amplifier 211a, the ADC 213, a detector 215′, and a driver 230′. Also, the coordinate measuring device 10d may further include the first to third control switches 220, 240, and 245. The coordinate measuring device 10d of FIG. 16 is a modified example of the coordinate measuring device 10b, and thus, the above descriptions with reference to FIG. 7 may be also applied to the coordinate measuring device 10d and are omitted below.

The panel 100 may include the plurality of first and second channel electrodes 111 to 113 and 121 to 123. According to the present exemplary embodiment, the second channel electrodes 121 to 123 are arranged in parallel with each other in the second direction (e.g., X-axis direction), and may be used both as the transmitting electrodes and the receiving electrodes. The first channel electrodes 111 to 113 are arranged in parallel with each other in the first direction (e.g., Y-axis direction), and may be used only as the receiving electrodes. As described above, since the plurality of first and second channel electrodes 111 to 113 and 121 to 123 are used as the receiving electrodes, a location of the coordinate indicating device 20 may be measured on a 2D plane.

At least one of the plurality of second channel electrodes 121 to 123 may transmit the driving signal Tsig for resonating the coordinate indicating device 20 to the coordinate indicating device 20 through a capacitive coupling with the coordinate indicating device 20. In more detail, at least one of the plurality of second channel electrodes 121 to 123 receives the driving signal Tsig from the driver 230, and transfers the driving signal Tsig to the coordinate indicating device 20. The coordinate indicating device 20 may obtain the energy for performing the resonance by receiving the driving signal Tsig.

Also, at least one of the plurality of first and second channel electrodes 111 to 113 and 121 to 123 may receive the resonance signal Rsig generated by the coordinate indicating device 20 through the capacitive coupling with the coordinate indicating device 20. At least one of the plurality of first and second channel electrodes 111 to 113 and 121 to 123 may receive the resonance signal Rsig from the coordinate indicating device 20, and may transfer the resonance signal Rsig to the amplifier 211a.

The amplifier 211a may amplify the resonance signal Rsig transmitted from at least one of the plurality of first and second channel electrodes 111 to 113 and 121 to 123. The ADC 213 may convert the resonance signal Rsig that is amplified from analog to a digital signal.

The detector 215′ detects at least one of the resonant frequency fr and the phase φd of the resonance signal Rsig from the digital signal, and may output a driving time signal DT that adjusts the driving signal Tsig adaptively to at least one of the resonant signal fr and the phase φr, which is detected. For example, the detector 215′ may include a DSP.

In more detail, the detector 215′ may detect the phase φr of the resonance signal Rsig from the digital signal. The detector 215′ may detect the phase φr of the resonance signal Rsig by performing at least one selected from a Fourier transformation, a fast Fourier transformation (FFT), and a discrete Fourier transformation (DFT) with respect to the digital signal.

In addition, the detector 215′ may determine the driving period of the driving signal Tsig so that the driving phase φd of the driving signal Tsig is to be in phase with the phase φr of the resonance signal Rsig. The detector 215′ may generate a driving time signal DT that is activated at the start point of the driving period. For example, the driving time signal DT may shift to a logic ‘1’ value at the start point of the driving period, and may shift to a logic ‘0’ value at a finish time of the driving period.

The driver 230′ may provide the driving signal Tsig to at least one of the second channel electrodes 121 to 123 during the driving period according to the driving time signal DT. In more detail, when the driving time signal DT is activated, that is, the driving time signal DT has the logic ‘1’ value, the driver 230′ outputs the driving signal Tsig. In addition, when the driving time signal DT is deactivated, that is, the driving time signal DT has the logic ‘0’ value, the driver 230′ may terminate outputting of the driving signal Tsig.

According to the exemplary embodiment, the driving time signal DT is generated based on the phase φr of the resonance signal Rsig, and the driving signal Tsig may be output in the driving period that is adjusted according to the driving time signal DT. Accordingly, the driving signal Tsig and the resonance signal Rsig may be in phases with each other, and thus, generation of the destructive interference may be prevented.

FIG. 17 is a block diagram of a coordinate measuring device 10e according to an exemplary embodiment.

Referring to FIG. 17, the coordinate measuring device 10e may include the panel 100, the amplifier 211a, the ADC 213, the detector 215′, the driving signal controller 250′, and the driver 230′. Also, the coordinate measuring device 10e may further include first to third control switches 220, 240, and 245. The coordinate measuring device 10e of FIG. 17 is a modified example of the coordinate measuring device 10d of FIG. 16, and thus, above descriptions with reference to FIG. 16 may be applied to the coordinate measuring device 10e. Thus, overlapping descriptions are omitted below.

According to the present exemplary embodiment, the detector 215′ detects at least one of the resonance frequency fr and the phase φr of the resonance signal Rsig from the digital signal that has been converted, and may output the driving time signal DT that adjusts the driving signal Tsig adaptively to at least one of the resonant frequency fr and the phase φr, which is detected. For example, the detector 215′ may include a DSP.

The driving signal controller 250′ may generate a control signal CON for controlling at least one of the driving frequency fd and the driving phase φd of the driving signal Tsig according to the driving time signal DT. For example, the driving signal controller 250′ may be formed as a micro controller unit (MCU).

The driver 230′ adjusts at least one of the driving frequency fd and the driving phase φd of the driving signal Tsig adaptively to the control signal CON, and may provide the driving signal Tsig to the at least one of the plurality of second channel electrodes 121 to 123. Therefore, the adjusted driving frequency fd of the driving signal Tsig may be equal to the resonant frequency fr of the resonance signal Rsig, or the adjusted driving phase φd of the driving signal Tsig may be equal to the phase φr of the resonance signal Rsig.

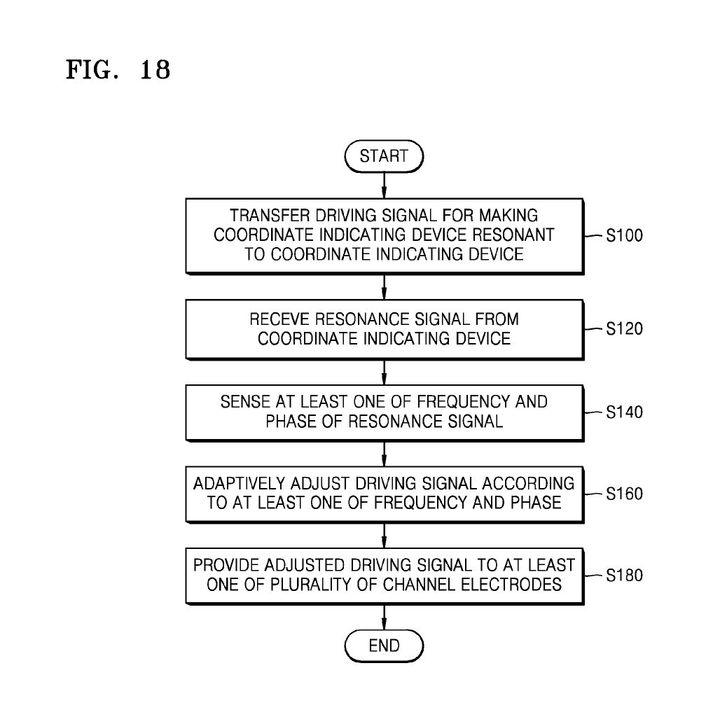

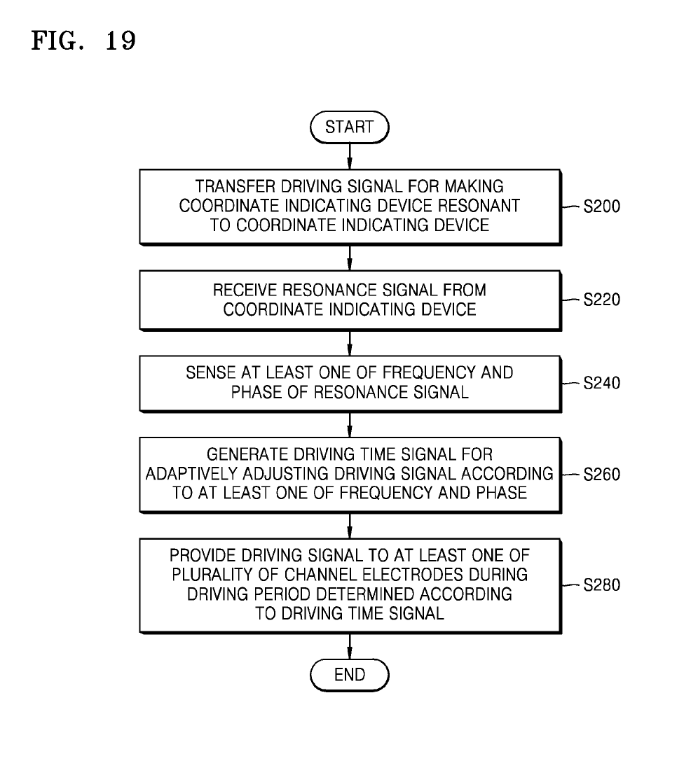

FIG. 18 is a flowchart illustrating a coordinate measuring method according to an exemplary embodiment.

Referring to FIG. 18, the coordinate measuring method according to the exemplary embodiment is a method of measuring a location of the coordinate indicating device on the coordinate measuring device including a plurality of channel electrodes, and includes following processes performed in the coordinate measuring device. For example, the coordinate measuring method according to the exemplary embodiment may include processes that are performed serially in time in the coordinate measuring device 10, 10a, 10b, or 10c shown in FIGS. 1, 2, 7, and 8.

In operation S100, the driving signal for making the coordinate indicating device 20 resonant is transferred to the coordinate indicating device 20. For example, at least one of the plurality of second channel electrodes 121 to 123 forms a capacitive coupling with the coordinate indicating device 20, and thereby transferring the driving signal Tsig to the coordinate indicating device 20.

In operation S120, the coordinate measuring device 10 receives the resonance signal from the coordinate indicating device 20. For example, at least one of the plurality of first and second channel electrodes 111 to 113 and 121 to 123 forms a capacitive coupling with the coordinate indicating device 20, and thereby receiving the resonance signal Rsig.

In operation S140, at least one of the frequency and the phase of the resonance signal is sensed. For example, the sensor 210 may sense at least one of the resonant frequency fr and the phase φr of the resonance signal Rsig. In the exemplary embodiment, the sensor 210 may convert the resonance signal to the digital signal from the analog signal, and may detect at least one of the frequency and the phase from the digital signal. In another exemplary embodiment, the sensor 210 amplifies the resonance signal to output an amplified resonance signal, converts the resonance signal, that is, an analog signal, to a digital signal, and may detect at least one of the frequency and the phase from the digital signal.

In operation S160, the driving signal is adjusted adaptively to at least one of the frequency and the phase. For example, the driver 230 may adaptively adjust at least one of the driving frequency fd and the driving phase φd of the driving signal Tsig based on the output from the sensor 210. In one exemplary embodiment, the driving frequency fd of the driving signal Tsig may be adjusted to be equal to the resonant frequency fr of the resonance signal Rsig. In another exemplary embodiment, the driving phase φd of the driving signal Tsig may be adjusted to be equal to the resonance phase φr of the resonance signal Rsig. In another exemplary embodiment, the driving timing of the driving signal Tsig may be determined according to the phase of the resonance signal Rsig.

In operation S180, the driving signal that has been adjusted is provided to one of the plurality of channel electrodes. For example, the driver 230 may provide the driving signal Tsig to at least one of the plurality of second channel electrodes 121 to 123.

Although not shown in FIG. 18, the coordinate measuring method may further include generating a control signal for controlling at least one of the driving frequency and the driving phase of the driving signal according to at least one of the frequency and the phase, which is sensed. Here, operation S160 may adjust the driving signal adaptively according to the control signal.

FIG. 19 is a flowchart illustrating a coordinate measuring method according to another exemplary embodiment.

Referring to FIG. 19, the coordinate measuring method according to the exemplary embodiment is a method of measuring a location of the coordinate indicating device by using the coordinate measuring device including a plurality of channel electrodes, and includes following processes performed in the coordinate measuring device. For example, the coordinate measuring method according to the present exemplary embodiment may include processes that are time-serially performed in the coordinate measuring device 10d or 10e shown in FIG. 16 or FIG. 17.

In operation S200, a driving signal for making the coordinate indicating device resonant is transferred to the coordinate indicating device. For example, at least one of the plurality of second channel electrodes 121 to 123 forms a capacitive coupling with the coordinate indicating device 20, and thereby transferring the driving signal Tsig to the coordinate indicating device 20.

In operation S220, the coordinate measuring device receives a resonance signal from the coordinate indicating device 20. For example, at least one of the plurality of first channel electrodes 111 to 113 forms a capacitive coupling with the coordinate indicating device 20, and thereby receiving the resonance signal Rsig.

In operation S240, at least one of the frequency and the phase of the resonance signal Rsig is sensed. For example, the detector 215′ may detect the phase φr of the resonance signal Rsig. In one exemplary embodiment, the sensor 210 may convert the resonance signal, that is, the analog signal, to the digital signal, and may detect at least one of the frequency and the phase from the digital signal. In another exemplary embodiment, the sensor 210 amplifies the resonance signal to output an amplified resonance signal, converts the amplified resonance signal, that is, an analog signal, to a digital signal, and may detect the phase from the digital signal.

In operation S260, a driving time signal DT for adaptively adjusting the driving signal according to at least one of the frequency and the phase is generated. For example, the detector 215′ determines a driving period of the driving signal Tsig according to the detected phase, and may generate the driving time signal DT that is activated at the start point of the driving period and deactivated at the finish point of the driving period.

In operation S280, the driving signal Tsig is provided to at least one of the plurality of channel electrodes during the driving period according to the driving time signal. For example, the driver 230′ may provide the driving signal Tsig to at least one of the plurality of second channel electrodes 121 to 123 during the driving period determined according to the driving time signal DT.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A coordinate measuring device for sensing a location of a coordinate indicating device including a resonant circuit, the coordinate measuring device comprising:
a panel comprising a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal; and
a controller configured to sense at least one of a frequency and a phase of the resonance signal and adjust the driving signal according to the at least one of the frequency and the phase.

2. The coordinate measuring device of claim 1, wherein the controller adjusts a driving frequency of the driving signal such that the driving frequency is equal to the frequency of the resonance signal.

3. The coordinate measuring device of claim 1, wherein the controller adjusts a driving phase of the driving signal such that the driving phase is equal to the phase of the resonance signal.

4. The coordinate measuring device of claim 1, wherein the controller comprises:
a sensor configured to sense the at least one of the frequency and the phase of the resonance signal and output information indicating the at least one of the frequency and the phase of the resonance signal.

5. The coordinate measuring device of claim 4, wherein the controller further comprises:
a driver configured to adjust the at least one of the driving frequency and the driving phase of the driving signal according to the output information and provide the adjusted driving signal to at least one of the plurality of channel electrodes.

6. The coordinate measuring device of claim 4, wherein the controller further comprises:
a driving signal controller configured to generate a control signal for controlling the at least one of the driving frequency and the driving phase of the driving signal according to the output information; and
a driver configured to adjust at least one of the driving frequency and the driving phase according to the control signal and provide the adjusted driving signal to at least one of the plurality of channel electrodes.

7. The coordinate measuring device of claim 4, wherein the sensor comprises:
an analog to digital converter (ADC) configured to convert the resonance signal from an analog signal to a digital signal; and
a detector configured to detect the at least one of the frequency and the phase of the digital signal.

8. The coordinate measuring device of claim 7, wherein
the sensor further comprises:
an amplifier configured to amplify the resonance signal and output the amplified resonance signal, wherein
the ADC is configured to convert the amplified resonance signal from an analog signal to a digital signal.

9. The coordinate measuring device of claim 7, wherein the detector is configured to transform the digital signal from a temporal domain to a frequency domain and detect the at least one of the frequency and the phase of the digital signal that has been transformed to the frequency domain.

10. The coordinate measuring device of claim 7, wherein the detector detects the at least one of the frequency and the phase by applying at least one of a Fourier transformation, a fast Fourier transformation (FFT), and a discrete Fourier transformation (DFT) to the digital signal.

11. The coordinate measuring device of claim 1, wherein the controller is configured to determine a timing of activating the driving signal according to the sensed phase.

12. A coordinate measuring device for sensing a location of a coordinate indicating device including a resonant circuit, the coordinate measuring device comprising:
a panel comprising a plurality of channel electrodes configured to transmit a driving signal to the coordinate indicating device through capacitive coupling with the coordinate indicating device and receive a resonance signal generated by the coordinate indicating device, wherein the coordinate indicating device resonates based on the driving signal;
an amplifier configured to amplify the resonance signal;
an analog to digital converter (ADC) configured to convert the amplified resonance signal from an analog signal to a digital signal; and
a detector configured to detect a phase of the digital signal and output a driving time signal for adjusting the driving signal according to the detected phase.

13. The coordinate measuring device of claim 12, further comprising:
a driver configured to provide the adjusted driving signal to at least one of the plurality of channel electrodes during a driving period according to the driving time signal.

14. A coordinate measuring system comprising:
a coordinate indicating device including a resonant circuit; and
a coordinate measuring device comprising:
a panel comprising a plurality of channel electrodes configured to transmit a driving signal to the coordinate indicating device through capacitive coupling with the coordinate indicating device, and receive a resonance signal generated by the coordinate indicating device, wherein the coordinate indicating device resonates based on the driving signal; and
a controller configured to sense at least one of a frequency and a phase of the resonance signal and adjust the driving signal according to the at least one of the frequency and the phase, which is sensed.

15. A coordinate measuring method for measuring a location of a coordinate indicating device in a coordinate measuring device including a plurality of channel electrodes, the coordinate measuring method comprising:
transmitting a driving signal to the coordinate indicating device through capacitive coupling between at least one of the plurality of channel electrodes and the coordinate indicating device, wherein the coordinate indicating device resonates based on the driving signal;
receiving a resonance signal from the coordinate indicating device through capacitive coupling between the at least one of the plurality of channel electrodes and the coordinate indicating device;
sensing at least one of a frequency and a phase of the resonance signal;
adjusting the driving signal according to the at least one of the frequency and the phase; and
providing the adjusted driving signal to at least one of the plurality of channel electrodes.

16. The coordinate measuring method of claim 15, wherein the adjusting of the driving signal comprises adjusting a driving frequency of the driving signal such that the driving frequency is equal to the sensed frequency.

17. The coordinate measuring method of claim 15, wherein the adjusting of the driving signal comprises adjusting a driving phase of the driving signal such that the driving phase is equal to the sensed phase.

18. The coordinate measuring method of claim 15, wherein the adjusting of the driving signal determines a timing of activating the driving signal according to the sensed phase.

19. The coordinate measuring method of claim 15, further comprising
generating a control signal for controlling at least one of a driving frequency and a driving phase of the driving signal according to the at least one of the frequency and the phase,
wherein the adjusting the driving signal comprises adjusting the driving signal according to the control signal.

20. The coordinate measuring method of claim 15, wherein the sensing of at least one of the frequency and the phase comprises:
converting the resonance signal from an analog signal to a digital signal; and
detecting at least one of the frequency and the phase of the digital signal.

21. The coordinate measuring method of claim 20, wherein
the sensing of at least one of the frequency and the phase further comprises amplifying the resonance signal and outputting the amplified resonance signal, and
the converting of the resonance signal from an analog signal to a digital signal comprises converting the amplified resonance signal from an analog signal to a digital signal.

22. A coordinate measuring method for measuring a location of a coordinate indicating device in a coordinate measuring device including a plurality of channel electrodes, the method comprising:
transmitting a driving signal to the coordinate indicating device through capacitive coupling between at least one of the plurality of channel electrodes and the coordinate indicating device, wherein the coordinate indicating device resonates based on the driving signal;
receiving a resonance signal from the coordinate indicating device through capacitive coupling between at least one of the plurality of channel electrodes and the coordinate indicating device;
detecting a phase of the resonance signal;
generating a driving time signal for adjusting the driving signal according to the sensed phase; and
providing the driving signal to at least one of the plurality of channel electrodes during a driving period set according to the driving time signal.

23. The method of claim 22, wherein the detecting of the phase comprises:
amplifying the resonance signal;
converting the amplified resonance signal from an analog signal to a digital signal; and
detecting the phase of the digital signal.
